(19) United States
(12) Patent Application Publication
(10) Pub. No.: US 2007/0144845 A1
(43) Pub. Date: Jun. 28, 2007

(54) Wheel suspension for vehicle

(76) Inventor: Takuya Saito, Kakegawa-shi (JP)

Correspondence Address: ERNEST A. BEUTLER, ATTORNEY AT LAW, 10 RUE MARSEILLE, NEWPORT BEACH, CA, 92660, US

(21) Appl. No.: 11/612,683

(22) Filed: Dec. 19, 2006

(30) Foreign Application Priority Data
Dec. 28, 2005 (JP) 2005-376809

(51) Int. Cl. B62K 17/00

(52) U.S. Cl. 188/281; 280/276

(57) ABSTRACT

Embodiments of suspension units for a wheel such as a dirigible wheel for a vehicle such as a motorcycle wherein the dampers at the opposite sides of the wheel each dampen only a compression or an expansion stroke respectively. This offers greater control and simplifies the construction.

### BACKGROUND OF THE INVENTION

This invention relates to a suspension system for a vehicle and more particularly to a suspension arrangement for a dirigible wheel for, by way of example, a steered wheel of a vehicle such as motorcycle type of vehicle, although the application for the invention is not so limited, as those skilled in the art will readily recognize.

The front wheel of a motorcycle is conventionally dirigibly journalled by a front fork made up of a pair of left and right front fork members each of which is double acting to dampen the movement of the vehicle body attitude due to irregularities on a road surface. Such a front fork is disclosed for example in Japanese Published Application Hei 10-119868 and as shown, for example in FIG. 1, hereof comprises a conventional, ordinary front fork, indicated generally by the reference numeral 11. A pair of symmetric, left and right front fork damping members 12a and 12b are interconnected via a bracket 13 to the lower end of a steering shaft 14. Handlebars (not shown) are connected, in a known manner, to the steering shaft 14, which is suitably journalled for dirigible movement by the front part of a vehicle body (not shown). A front wheel (not shown) is supported for free rotation via a wheel shaft (not shown) fixed to brackets 15 formed at the lower ends of the front fork damping members 12a and 12b. Thus and as well known in the art, the front wheel is steered via the steering shaft 14 and the front fork 11 using the handlebars.

In this conventional prior art structure, each of the front fork damping members 12a and 12b is of the same construction comprised of concentric outer and inner cylinders 16 and 17 each configured and constructed to be double acting. The interior of the inner cylinders 16, 17 is divided by a respective piston 18 into an upper, compression side oil chamber C and a lower, expansion side oil chamber D. The pistons 18 are held in a fixed axial position relative to the steering shaft 14 by means of a respective piston rod 19 in any suitable manner.

The compression side oil chamber C experiences compressive action in compression stroke, while the expansion side oil chamber D receives compressive action in expansion stroke. Each piston 18 has a mechanism for producing damping force and a base valve 21 having a mechanism for producing damping force is disposed at the lower end of the respective inner cylinder 16 and 17 coaxially with its respective piston 18.

The damping action of the prior art construction will flow be described by reference to FIGS. 2A and 2B that are partial, enlarged views of the piston 18 shown in FIG. 1. The damping action with the left and right damping members 12a and 12b, is the same, as has been noted. The arrows show the direction of oil flow. FIG. 2A shows the compression stroke and FIG. 2B shows the flow during the expansion stroke.

Each piston 18 is formed a first passage 22 and a second passage 23 for providing fluid communication between a respective compression side oil chamber C and a respective expansion side oil chamber D. At the expansion chamber side opening of the each first passage 22 is provided a respective compression valve 24 capable of opening during compression stroke of the piston rod 19, while at the compression chamber side opening of the second passage 23 is provided a respective expansion valve 25 capable of opening during the expansion stroke.

As best seen in FIGS. 2A and 2B, the lower end portion of each of the piston rods 19 is formed an axial, in-shaft passage 26 in fluid communication with the compression side oil chamber C and an upper passage 27 for fluid communication between the in-shaft passage 26 and the expansion side oil chamber D. Consequently, the compression side oil chamber C and the expansion side oil chamber D are in fluid communication via the in-shaft passages 26 and 27.

Also, a respective damping force regulation valve 28 is positioned in the interior of the respective piston rod 18 for axial movement. At the lower end of the damping force regulation valve 28, a conical needle 29 is positioned inside the in-shaft passage 26. Movement of the needle 29 back and forth, regulates the amount of oil flowing through the in-shaft passage 26 so as to regulate damping force in particular in low speed range during the expansion stroke.

As shown in FIG. 2A, during a compression stroke, the pressure in the expansion side oil chamber D lowers as the piston 18 is pushed down. Consequently, the oil in the pressure in the compression side oil chamber C pushes the compression valve 24 open and oil flows through the first passage 22 into the expansion side oil chamber D, and at the same time, moves through the in-shaft passage 26 and the passage 27 into the expansion side oil chamber D. Here, as resistance is small, little damping force is produced.

At this time, as the piston rod 19 is inserted into the inner cylinder 17, the pressure in the entire interior of the cylinder increases corresponding to the inserted volume of the piston rod 19. Consequently, the amount of oil flowing from the compression side oil chamber C to the expansion side oil chamber D corresponds to an amount derived from the difference between the cross-sectional area of the inner cylinder 17 less the cross-sectional area of the piston rod 19.

As shown in FIG. 2B, during an expansion stroke, as the piston 18 is pulled tip, the pressure of the expansion side oil chamber D rises, while the pressure of the compression side oil chamber C lowers. Consequently, the oil in the expansion side oil chamber D pushes open the expansion time valve 25 to move through the second passage 23 into the compression side oil chamber C, and also moves front the passage 27 through the in-shaft passage 26 into the compression side oil chamber C, and this resistance produces expansion damping force.

Again, at this time, the amount of oil flowing from the expansion side oil chamber D into the compression side oil chamber C, as the pressure in the expansion side oil chamber D lowers is equal to cross-sectional area of the inner cylinder 17 minus the cross-sectional area of the piston rod 18.

Referring now to FIGS. 3A and 3B, these show the actions of the base valve 21 with the flow directions being indicated by the arrows. FIG. 3A shows the compression stroke while FIG. 3B illustrates the expansion stroke. Thus these figures correspond to FIGS. 2A and 2B.

As has been noted, the base valves 21 are provided at the lower end portion of the respective inner cylinders 17. They serve the function of accommodating the fluid displaced due to the cross sectional area of the piston rod 19, by either receiving this fluid or replacing it depending on whether compression or expansion are occurring.

In each of these base valves 21, a third passage 31 and a fourth passage 32 are formed to provide fluid communication between the respective compression oil chamber C and the respective outer cylinder 16 through a hole 33 provided in the respective inner cylinder 17. A compression valve 34 is provided at the lower opening of each of the third passage 31 that opens during the compression stroke. In a similar manner, the compression opening of the fourth passage 32 is provided an expansion valve 35 that opens during the expansion stroke.

Also an in-shaft passage 36 is axially formed in each of the base valves 21, to provide fluid communication between the compression side oil chamber C and the fore-end of the respective inner cylinder 17, and also a respective passage 37 is formed to provide fluid communication between the in-shaft passage 36 and the respective outer cylinder 16. Into each of these passage 37, a respective conical needle 38 is movably supported for regulating damping force. By moving the position of the needles 38 back and forth, the amount of oil flowing through the passages 37 via the needles 38 is regulated so as to regulate damping force.

As shown in FIG. 3A in a compression stroke, the excessive oil corresponding to the inserted volume of the piston rod 18 that does not flow into the expansion side oil chamber D in FIG. 2A flows to the in-shaft passage 36 and also pushes open the compression valve 34 disposed in the third passage 31. The oil having passed into the in-shaft passage 36 flows from the needle 38 through the passage 37 into the outer cylinder 16. The oil having passed from the compression valve 34 flows through the hole 33 of the inner cylinder 17 to the outer cylinder 16. By this resistance, compression damping force is produced.

As shown in FIG. 3B, during an expansion stroke, the oil corresponding to the displaced volume of the piston rod 18 flows from the outer cylinder 16 through the hole 33 of the inner cylinder 17 and, while pushing open the expansion valve 35, into the compression side oil chamber C. Here, resistance is small and no significant damping force is produced.

As a result, as the piston 18 moves axially in the inner cylinder 17 due to irregularities on the road surface, damping forces during expansion and compression are produced Damping force characteristics are set so that damping forces matching the road surface conditions may be obtained to realize operability and ride comfort the user desires.

Thus with the prior art, hydraulic damping mechanism is obtained in each of the left and right front fork members, and both compression side damping force and expansion side damping force are produced and regulated in each of the front fork members. That is, the conventional left and right front fork members are the same in construction and operation. Basically, damping forces on the both compression and the expansion are respectively regulated to be the same on both sides. In other words, each of left and right front fork members are double acting.

This has been the practice because it was generally assumed that to do otherwise would adversely affect maneuverability due to left and right imbalance in damping force. Consequently, conventional front fork members have been of a pair of double acting devices that are the same in construction.

However, proving mechanisms for producing and regulating the compression side and expansion side damping forces respectively likewise on each of the left and right front fork members makes the respective front fork members complicated and expensive This results in addition of structures in excess. That is, providing damping force producing mechanisms for both compression and expansion sides respectively on both left and right front fork members of a single front fork is not the most efficient or effective. Excess damping forces are sometimes produced, causing inefficient production of damping force.

In addition the conventional hydraulic damping mechanism described above the oil acting for providing compression side damping force is used only in amount corresponding to the cross-sectional area of the piston rod 18 and therefore small in flow rate and does not provide sufficient compression side damping force relative to the cross-sectional area of the entire inner cylinder 17. Consequently, the compression side damping force is inadequate.

In addition recent vehicles of light weight and high output such as of sports models, require high stabilized maneuverability. This can be accomplished by increasing compression damping force and at the same time to improve responsiveness in the expansion side damping. It is further required to obtain damping forces in compression stroke and expansion stroke while quickly to responding to switching between these strokes. Such requirements of high performance are difficult to meet using the front fork based on the conventional, double acting hydraulic damping mechanism.

### SUMMARY OF THE INVENTION

The inventor hereof has discovered that the previously believed theory of using identical paired double acting hydraulic mechanisms really is not required for stability. In fact performance and stability can in fact be obtained by employing paired, oppositely acting single hydraulic mechanisms on the opposite sides of the front fork.

Therefore it is a principal object of the invention to provide a wheel suspension for a vehicle having dampers provided on opposite sides of the wheel rotational axis, one of which acts to only dampen movement on compression and the other of which operates only to dampen movement on expansion.

In accordance with another feature of the invention the suspended wheel is supported for dirigible movement.

### BRIEF DESCRIPTION OF THE DRAWINGS

FIG. 1 is a front elevational view, with portions broken away, of a conventional prior art front wheel suspension for a motorcycle.

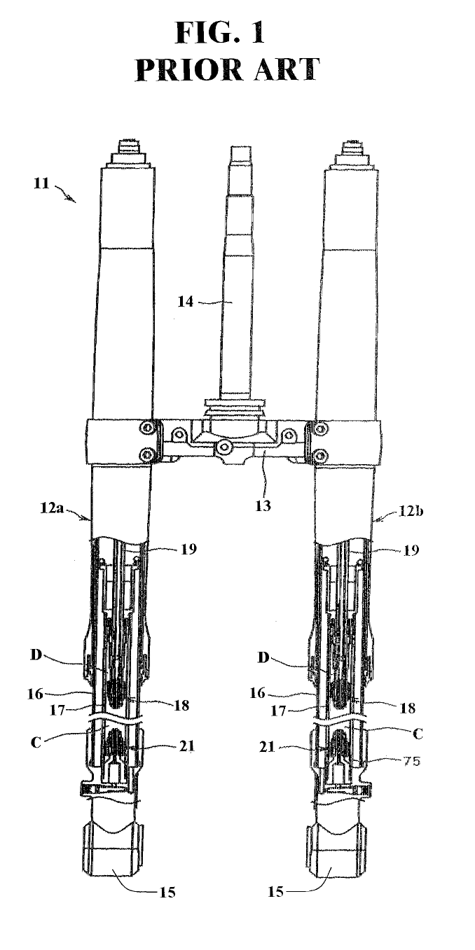

FIGS. 2A and 2B are enlarged views showing the flow through the piston valves of each shock absorber during a compression stroke and the following expansion stroke.

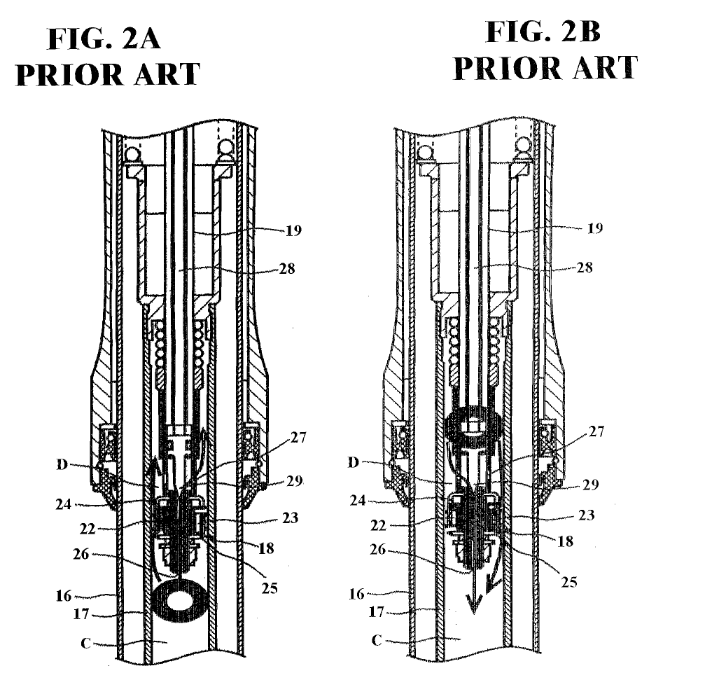

FIGS. 3A and 3B are enlarged views showing the flow through the base valves of each shock absorber during a compression stroke and the following expansion stroke.

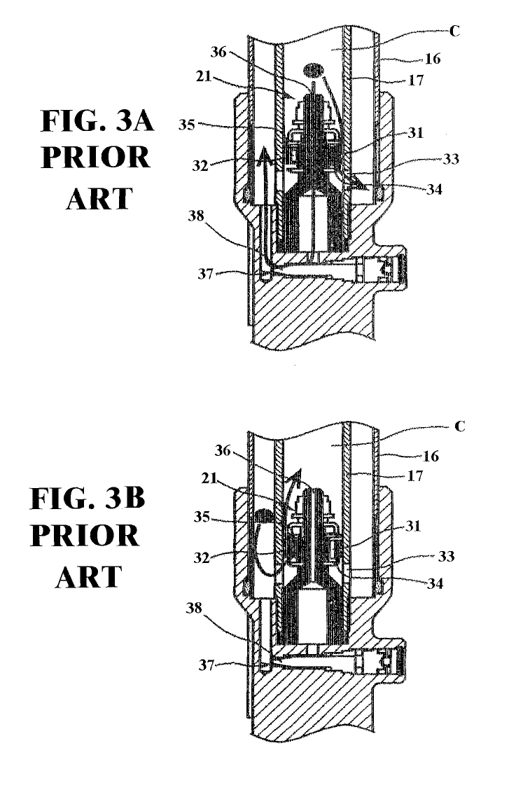

FIG. 4 is a front elevational view, with portions broken away, in part similar to FIG. 1, but showing an embodiment of the invention.

FIGS. 5A and 5B are enlarged views, in part similar to FIGS. 2A and 2B, but showing the flow in the left and right shock absorbers, respectively, of this embodiment during a compression stroke.

FIGS. 6A and 6B are enlarged views, in part similar to FIGS. 2A and 2B, but showing the flow in the left and right shock absorbers during an expansion stroke.

FIG. 7 is a view in part similar to those of FIGS. 2A and 2B and 3A and 3B, but showing a different embodiment.

### DETAILED DESCRIPTION

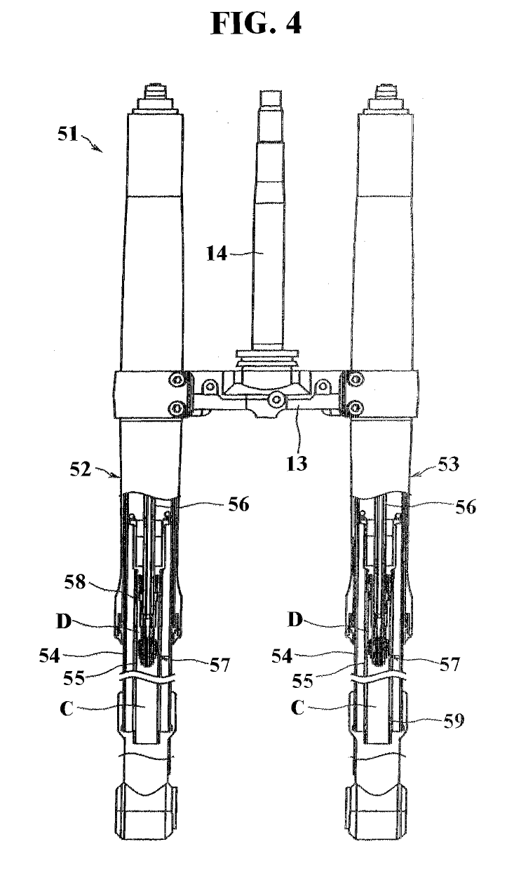

Referring now in detail to the illustrated embodiments of the invention and initially to FIG. 4, like the prior art construction the front wheel (not shown) is dirigibly supported for steering movement by a steering shaft 14 that supports handlebars (not shown) provided in the front part of an associated vehicle body (not shown). At the fore-end of a front fork, indicated generally by the reference numeral 51, a front wheel (not shown) is rotatably supported through a wheel shaft (not shown). Thus, the front wheel is steered through the steering shaft 14 and the front fork 51 using the handlebars.

Unlike the prior art, the suspension comprises left and right damper units, each indicated by the respective reference numerals 52 and 53. Each of the damper units 52 and 53 is comprised of coaxial outer cylinders 54 and inner cylinders 55.

Each damper unit 52 and 53 also includes a piston rod 56 axially movable in its inner cylinder 55. A piston 57 is fixed to the lower end of each of the piston rods 56 and divides the interior of the inner cylinder 55 into a contraction side oil chamber C on the lower side of the piston 57 and the extension side oil chamber D on the back face side of the piston 57. The contraction side oil chamber C receives compressive action in contraction stroke, while the extension side oil chamber D receives compressive action in extension stroke.

Now the difference between the damper units 52 and 53, will be described. In the left hand damper unit 52, a hole 58 is formed in the inner cylinder 55 that is open toward the outer cylinder 54. This provides communication between the interior of the inner cylinder 55 and the annular space between both cylinders 54 and 55 on the back face side of the piston 57, of the inner cylinder 55. On the other hand, a hole 59 that is open toward the outer cylinder 54 (to make communication between the interior of the inner cylinder 55 and the annular space between both cylinders 54 and 55) is formed in part of the side face, on the front face side of the piston 57, of the inner cylinder 55 of the other (right side in the figure) front fork member 53.

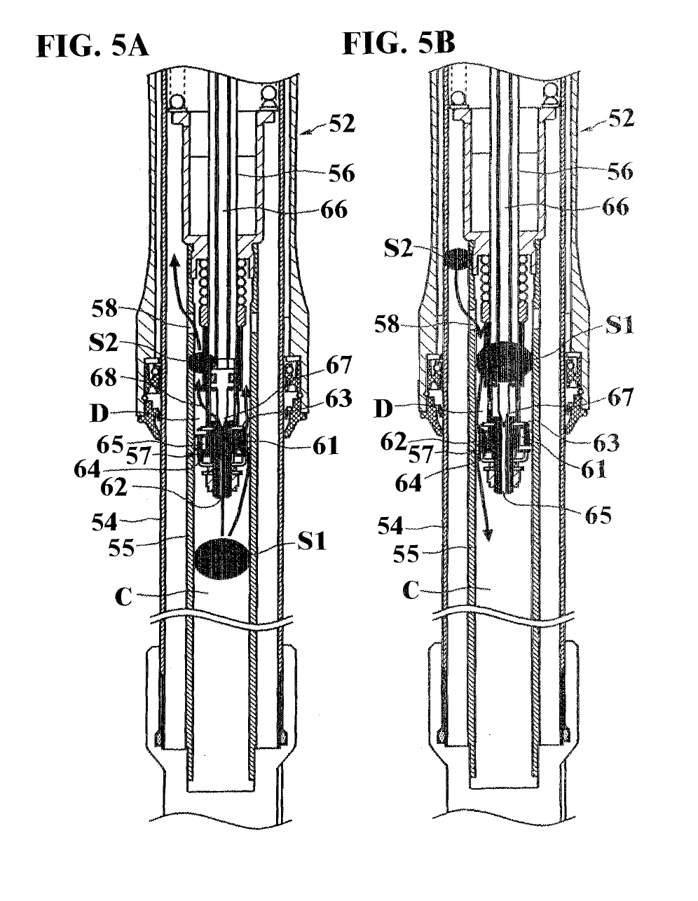

FIGS. 5A and 5B are partial, enlarged views of the left damper member 52, that produces the contraction side damping force through the use of the hole 58, formed in part of the inner cylinder 55 on the back face side of the piston 57 and opening toward the outer cylinder 55. The arrow indicates the oil flow direction. FIG. 5A shows the contraction stroke, while FIG. 5B illustrates the extension stroke.

Continuing to refer to these figures (5A and 5B), a first passage 61 and a second passage 62 are formed through the piston 57 for providing fluid communication between the contraction side oil chamber C and the extension side oil chamber D. At the opening facing the extension side oil chamber D of the first passage 61, a contraction valve 63 is provided which opens during the contraction stroke of the piston rod 56. Likewise, at the opening facing the contraction side oil chamber C of the second passage 62, an extension valve 64 is provided which opens during the extension stroke of the piston rod 56. The contraction valve 63 and the extension valve 64 for example be either single or plural plate valves made of for example annular, thin plate springs, to be pushed open with oil flow. Further, an in-shaft passage 65 for permitting fluid communication with the contraction side oil chamber C is formed along the center axis direction of the piston 57.

A damping force regulating valve 66 is inserted to be axially movable in the axis of the piston rod 56. A needle 67 of a conical shape is formed at the fore-end of the damping force regulating valve 66. The needle 67 is placed to be movable back and forth between a position for fully closing the base end side opening of the in-shaft passage 65 and a position for fully opening it. The oil having entered the in-shaft passage 65 during contraction stroke is controlled with the needle 67 and flows into the extension side oil chamber D. By adjusting the position of the needle 67, oil flow rate is controlled and damping force is regulated. Adjusting the position of the needle 67 to control the flow rate may be done with an adjusting section (not shown) provided on the base (upper) end of the damping force regulating valve 66.

As has been noted, in part of the inner cylinder 55 on the back face side of the piston 57, the hole 58 is formed which leads to the outer cylinder 54. When the piston rod 56 is inserted in the compressing direction (down in the figure), in response to hitting a bump or the like, oil in an amount corresponding to the inserted portion of the piston rod 56 flows through the hole 58 into the space defined between the outer cylinder 54 and the inner cylinder 55, as indicated by the flow arrow.

Considering this condition, the contraction side damping force producing mechanism of the front fork member 52 will be described in detail and referring primarily to FIG. 5A. When the front fork member 52 comes to a compressed state as the wheel is pushed up with a bump on the road surface, both of the cylinders 54, 55 move toward the base end (upward in the figure). As a result, the piston 57 is relatively pushed down. At this time, pressure in the contraction side oil chamber C increases. Consequently, oil flows up in the figure, and the contraction valve 63 is pushed open. When the contraction valve 63 opens, oil flows through the first passage 61 into the extension side oil chamber D. At this time, damping force is produced with the passage resistance of the contraction valve 63. Further, when the pressure in the contraction side oil chamber C increases, part of oil flows from the in-shaft passage 65 through the needle 67 and a passage hole 68 into the extension side oil chamber D. In normal and low speed drive, oil flows through the in-shaft passage 65 into the extension side oil chamber D. As the drive speed increases, oil pushes open the contraction valve 63, so that increased or greater damping force is produced.

In addition, as the piston rod 56 is inserted into the inner cylinder 55 during the contraction stroke, an amount of oil in the extension side oil chamber D corresponding to the inserted volume of the piston rod 56 becomes excessive. This excessive oil flows through the hole 58 into the outer cylinder 54. Thus, the pressure in the extension side oil chamber D is prevented from rising and the oil flow through the contraction valve 63 is made smooth, so that sufficient damping force is produced during contraction. Therefore, oil in the contraction side oil chamber C in an amount corresponding to the entire cross-sectional area of the inner cylinder 55 (S1 in the figure) contributes to producing damping force during contraction, so that sufficient damping force during contraction is obtained efficiently.

Continuing to refer to the action of the left damper 52, during the extension stroke when the piston 57 moves in the opposite direction as shown in FIG. 5B, the pressure in the contraction side oil chamber C decreases. During this time, oil flows down in this figure, pushes open the extension valve 64, and flows through the second passage 62 into the contraction side oil chamber C. The resistance of the extension valve 64 is so small that no damping force is produced. At this time, the deficit amount of oil corresponding to the drawn out volume of the piston rod 56 (the volume corresponding to S2 in the figure) is supplied from the outer cylinder into the inner cylinder 59 through the hole 58.

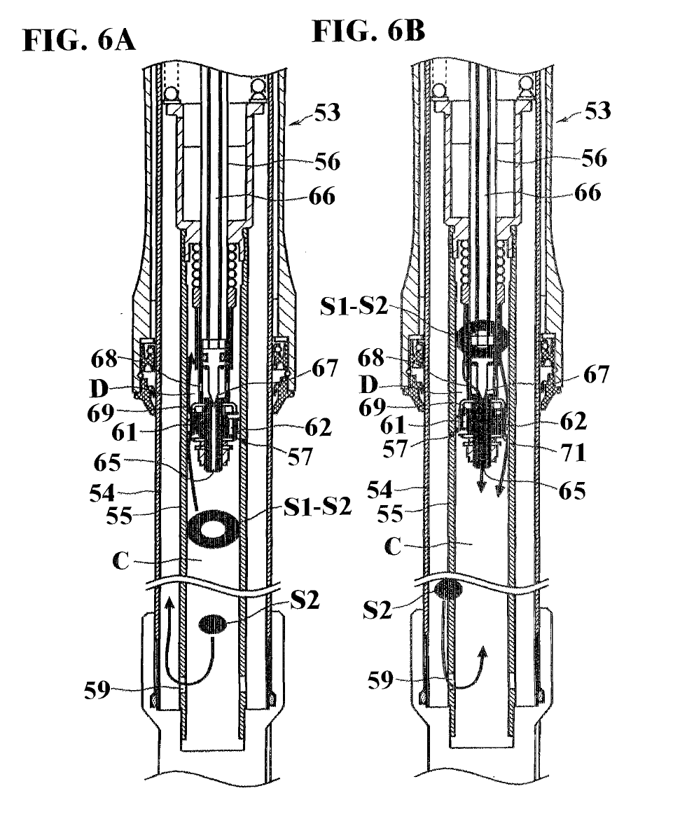

Now the operation of the right damper 53 will be described by reference to FIGS. 6A and 6B during the same conditions shown in FIGS. 5A and 5B, respectively. These FIGS. 6A and 6B are enlarged views of the front fork member 53, on the side producing extension side damping force. The piston rod 56 and the piston 57 are of the same construction as those of the other front fork damping member 52.

As the piston 57 is pushed down in the figure during contraction stroke, the pressure in the extension side oil chamber D decreases. Consequently, as shown in FIG. 6A, oil flows up in the figure, pushes open a contraction valve 69, and flows through the first passage 61 into the extension side oil chamber D. During this time, the resistance of the contraction valve 69 is very small, so that no damping force is produced.

At this time, the excess amount of oil in the contraction side oil chamber C due to the compressive action of the piston 57 flows through the hole 59 near the fore-end of the inner cylinder 55 into the outer cylinder 54.

During the extension stroke, as the pressure in the extension side oil chamber D rises, oil flows as shown in FIG. 6B, and pushes open an extension valve 71, and flows through the second passage 62 into the contraction side oil chamber C. During this time, damping force is produced with the passage resistance of the extension valve 71. In addition, as the pressure in the extension side oil chamber D rises, part of oil flows through the passage hole 68, the needle 67, and the in-shaft passage 65 into the contraction side oil chamber C.

As the piston 57 is drawn out during the extension stroke, the volume of the contraction side oil chamber C increases, so that make up oil is required. For the short amount required, the oil accumulated in the space between the outer cylinder 54 and the inner cylinder 55 flows through the hole 59 into the inner cylinder 55. This prevents oil flowing into the contraction side oil chamber C from running short and falling in pressure. Moreover, as no valves like those in the conventional constitution are present, oil flows easily and smoothly, so that sufficient damping force during extension is produced.

Thus, by appropriately adjusting the valves and needles of the left and right front fork members 52, 53 respectively to produce damping force during contraction with one member and produce damping force during extension with the other, both the front fork members 52, 53 become simple in constitution. Along with it, as oil flow is simplified, oil flows smoothly and efficiently to produce appropriate damping force, so that smooth maneuverability is provided.

In addition, as no base valves or the like for producing damping force need be provided and the length of the fore-end portion of the front fork damper members 52 and 53 may be shortened. Therefore, it is possible to provide sufficient stroke by making the inner cylinder 55 part long enough.

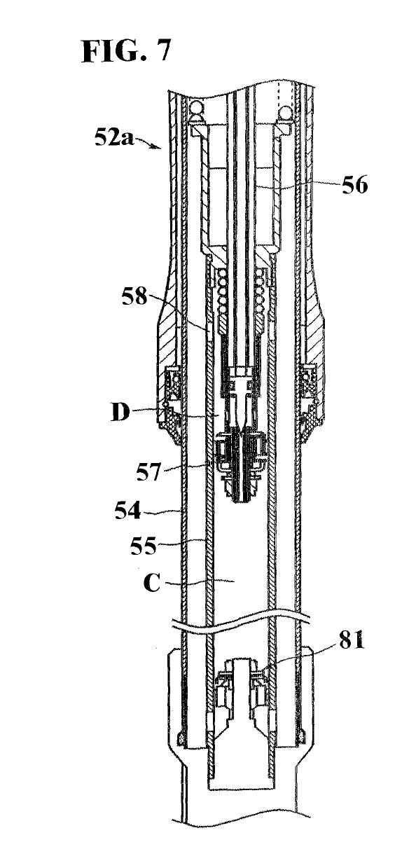

FIG. 7 illustrates a different compression damper element that could be used rather than the construction shown in FIGS. 5A and 6A. This unit is identified by the reference numeral 52a and except as will be noted, is the same as the previously described embodiment. For that reason, components that have substantially the same construction and operation are identified by the same reference numerals.

In essence, the front fork member incorporates a one-way valve 81 that opens up during extension stroke provided at the fore-end portion of the inner cylinder 55.

This one-way valve 81 remains in closed state due to the internal pressure in the contraction side oil chamber C during contraction stroke. However the one-way valve 81 opens up during extension stroke for adding an oil supply passage to the contraction side oil chamber C to compensate for the low pressure during extension stroke thus making it possible to prevent a shortage of oil acting during contraction stroke from running low and further improve responsiveness of damping force.

Thus from the foregoing description it should be readily apparent from the foregoing description that the described embodiments utilizing separately constructed dampers for respective compression and expansion damping father than like constructed dampers that each functions to dampen the movement in both directions a less expensive and better acting damper arrangement results without sacrificing handling or performance. Of course those skilled in the art will readily understand that the foregoing description is of exemplary of acceptable constructions and various changes and modifications may be made without departing from the spirit and scope of the invention, as defined by the appended claims.

1. A wheel suspension for a vehicle having dampers provided on opposite sides of the rotational axis of the suspended wheel, one of said dampers acting to dampen motion of said wheel primarily only on compression, and the other of said dampers operating only to dampen movement primarily on expansion.

2. A wheel suspension as set forth in claim 1, wherein the wheel is dirigibly supported by a dirigible fork assembly with the dampers being positioned on respective sides of the dirigible axis.

3. A wheel suspension as set forth in claim 2, wherein the dampers act as fork members.

4. A wheel suspension as set forth in claim 3, wherein each of the dampers is comprised of an outer cylinder and an inner cylinder, a piston is attached to the upper end of a piston rod inserted in the inner cylinder to divide the interior of the inner cylinder into a contraction side oil chamber compressed in a contraction stroke and an extension side oil chamber compressed in an extension stroke, one of said damper members using as a damping mechanism, a hole opening toward the outer cylinder is formed in the inner cylinder of the extension side oil chamber, the other of said dampers using as a damping mechanism a hole opening toward the outer cylinder is formed in the inner cylinder of the contraction side oil chamber.

5. A wheel suspension as set forth in claim 4, wherein the pistons of each of the dampers is formed with is a first passage and a second passage for interconnecting between the contraction side oil chamber and the extension side oil chamber are formed in the piston; a contraction time valve capable of opening during contraction stroke is disposed at an opening leading to the extension side oil chamber of the first passage, and an extension time valve capable of opening during contraction stroke is disposed at an opening leading to the contraction side oil chamber of the second passage.

6. A wheel suspension as set forth in claim 5, wherein the contraction side oil chamber of the front fork member provided with the first damping mechanism is in fluid communication with the outer cylinder via a one-way valve that opens up during extension stroke.
